(19) United States
(12) Patent Application Publication
(10) Pub. No.: US 2021/0334888 A1
(43) Pub. Date: Oct. 28, 2021

(54) GRAPHICAL USER INTERFACE FOR E-COMMERCE KITCHEN REMODELING

(71) Applicant: General Pacific LLC, Watertown, MA (US)

(72) Inventors: Andre Mai, Watertown, MA (US); Khoa Van Nguyen, Ho Chi Minh City (VN); Vien Hoang Nguyen, Phu Yen (VN)

(21) Appl. No.: 17/135,788

(22) Filed: Dec. 28, 2020

Related U.S. Application Data
(60) Provisional application No. 62/704,114, filed on Apr. 22, 2020.

(51) Int. Cl. G06Q 30/06; G06T 17/10; A47B 77/02

(52) U.S. Cl. CPC G06Q 30/0643; G06Q 30/0625; A47B 77/02; G06T 17/10; G06Q 30/0635

(57) ABSTRACT

A method provides a user interface for selecting cabinets. The method displays a web-browser user interface with an interactive 3D model. The 3D model includes a plurality of different cabinet types. Each of the plurality of different cabinet types is selectable by the user from the interactive 3D model. The user makes the selection by selecting the graphical representation of the cabinet type from the interactive 3D model. The method displays available cabinet options along with the interactive 3D model in the web-browser user interface. The available cabinet options are associated with the selection of the cabinet type. The method also receives a selection, in the web-browser user interface, of one of the available cabinet options to add to a shopping cart. The selection defines a selected cabinet. The method displays the shopping cart along with the interactive 3D model in the web-browser user interface. The shopping cart includes the selected cabinet.

### PRIORITY

This patent application claims priority from U.S. provisional patent application No. 62/704,114, filed Apr. 22, 2020, entitled, “GRAPHICAL USER INTERFACE FOR SELECTING PRODUCTS,” and naming Andre Mai, Khoa Van Nguyen, and Vien Nguyen, as inventors, the disclosure of which is incorporated herein, in its entirety, by reference.

### FIELD OF THE INVENTION

Various embodiments of the invention generally relate to improved e-commerce shopping experiences for kitchen remodeling and, more particularly, various embodiments relate to a graphical user interface for shopping for kitchen cabinets.

### BACKGROUND OF THE INVENTION

U.S. homeowners spent $147.3 billion on kitchen and bath products (excluding labor and design services) in both new construction and remodeling/replacement projects in 2016, according to the Kitchen & Bath Market Outlook study from the National Kitchen+Bath Association (NKBA). Specifically, $92.9 billion of the $147.3 billion comes from remodeling and replacement projects. The U.S. residential kitchens market, including both new construction and remodeling projects, spent $74.1 billion on products in 2016, an increase from the $67.3 billion spent on kitchen products in 2015. Remodeling and replacement projects accounted for 73% of the $74.1 billion. Despite the large expenditures on remodeling kitchens, purchasing kitchen cabinets is confusing for many retail customers.

### SUMMARY OF VARIOUS EMBODIMENTS

In accordance with one embodiment of the invention, a computer-implemented method provides a user interface for selecting cabinets in a system. The system includes a server in communication with an internet-coupled user computing device over a first network that includes the internet. The method serves a web page to the internet-coupled user computing device that displays a web-browser user interface with an interactive 3D model of a cabinet layout. The 3D model includes a plurality of different cabinet types. Each of the plurality of different cabinet types is selectable by the user from the interactive 3D model. The method receives a selection of a cabinet type from a user. The user makes the selection by selecting the graphical representation of the cabinet type from the interactive 3D model. The method serves an updated version of the web page that displays available cabinet options along with the interactive 3D model in the web-browser user interface. The available cabinet options are associated with the selection of the cabinet type. The method also receives a selection, in the web-browser user interface, of one of the available cabinet options to add to a shopping cart. The selection defines a selected cabinet. The method serves an updated version of the web page that displays the shopping cart along with the interactive 3D model in the web-browser user interface. The shopping cart includes the selected cabinet.

The method further receives a second selection of a second cabinet type from the user. The selection is made by the user selecting the graphical representation of the second cabinet type from the interactive 3D model. The method then serves an updated version of the web page that displays available cabinet options in the web-browser user interface. The available cabinet options are associated with the second selection.

The method also receives a selection, in the web-browser, of one of the available cabinet options to add to the shopping cart. The selection defines a second selected cabinet. An updated version of the web page that displays an updated shopping cart, in the web-browser user interface, is served to the user. The updated version of the web page includes the second selected cabinet.

Additionally, the method may serve an updated version of the web page that displays the web-browser user interface with a pictorial representation of a plurality of cabinet styles. Each of the plurality of different cabinet styles may be selectable. Some embodiments may receive a selection of a cabinet style from a user. The selection may be made by the user selecting the pictorial representation of the cabinet style from the web-browser user interface. Among other things, the method may display the available cabinet options in the web-browser user interface. The available cabinet options may be associated with the selection of the cabinet type and the cabinet style.

The interactive 3D model may include tall cabinets, refrigerator cabinets, wall cabinets, corner cabinets, microwave cabinets, island cabinets, base cabinets, and sink cabinets. Furthermore, the available cabinet options may be associated with the selection of the cabinet type include a variety of cabinet sizes. Additionally, some embodiments may serve an updated version of the web page displaying a second shopping cart as an overlay.

In accordance with another embodiment, a system for shopping for cabinets includes a 3D model engine. The 3D model engine is configured to generate a 3D model of a kitchen including a plurality of cabinet types. A web-browser user interface module is configured to serve a web page with the interactive 3D model including the plurality of different cabinet types. Each of the plurality of different cabinet types is selectable by a user from the interactive 3D model. A type selection module is configured to receive a selection of a cabinet type from the user. The selection is made by the user selecting the graphical representation of the cabinet type from the interactive 3D model. The system also includes a cabinet display module configured to serve an updated version of the web page that displays available cabinet options along with the interactive 3D model in the web-browser user interface. The available cabinet options are associated with the selection of the cabinet type. A shopping cart module is configured to generate a shopping cart within the web page as a function of receiving a selection, in the web-browser user interface, of one of the available cabinet options to add to a shopping cart. The selection defines a selected cabinet. The web-browser user interface module is further configured to serve an updated version of the web page that displays the shopping cart along with the interactive 3D model in the web-browser user interface. The shopping cart includes the selected cabinet.

In some embodiments, the type selection module is further configured to receive a second selection of a second cabinet type from the user. The selection may be made by the user selecting the graphical representation of the second cabinet type from the interactive 3D model. The web-browser user interface module may be further configured to serve an updated version of the web page that displays available cabinet options in the web-browser user interface. The available cabinet options may be associated with the second selection.

The shopping cart module further may be further configured to generate an updated shopping cart within the web page as a function of receiving a selection, in the web-browser, of one of the available cabinet options to add to the shopping cart. The selection defines a second selected cabinet. Additionally, the web-browser user interface module may further be configured to serve an updated version of the web page that displays an updated shopping cart, in the web-browser user interface, that includes the second selected cabinet.

The system may also include a style selection module that is configured to display a pictorial representation of a plurality of cabinet styles within the web page. Each of the plurality of different cabinet styles may be selectable. The style selection module may be configured to receive a selection of a cabinet style from the user. The selection is made by the user selecting the pictorial representation of the cabinet style from the web-browser user interface.

In some embodiments, the web-browser user interface module is further configured to serve an updated version of the web page to display the available cabinet options in the web-browser user interface. The available cabinet options may be associated with the selection of the cabinet type and the cabinet style. The interactive 3D model may include, among other things, tall cabinets, refrigerator cabinets, wall cabinets, corner cabinets, microwave cabinets, island cabinets, base cabinets, and sink cabinets.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

The patent or application file contains at least one drawing executed in color. Copies of this patent with color drawing(s) will be provided by the Patent and Trademark Office upon request and payment of necessary fee.

Those skilled in the art should more fully appreciate advantages of various embodiments of the invention from the following “Description of Illustrative Embodiments,” discussed with reference to the drawings summarized immediately below.

FIG. 1 shows an example of a kitchen in accordance with illustrative embodiments of the invention

FIG. 2 schematically shows a system configured to generate an online web-browser enabled interactive graphical user interface for simplifying online shopping for kitchen cabinets, in accordance with illustrative embodiments of the invention.

FIG. 3 shows a process of generating an interactive web-browser enabled user interface for selecting and purchasing kitchen cabinets using a 3D model in accordance with illustrative embodiments of the invention.

FIG. 4 shows a screenshot of the web-browser window user interface including the 3D model in accordance with illustrative embodiments of the invention.

FIG. 5 schematically shows the selected type highlighted within the web-browser window in accordance with illustrative embodiments of the invention.

FIG. 6 schematically shows the available cabinets shown graphically within the same web-browser display of FIG. 5.

FIG. 7 schematically shows an example of adding one of the available cabinets to the cart in accordance with illustrative embodiments of the invention.

FIG. 8 schematically shows the shopping cart in the same web-browser user interface of FIG. 5 in accordance with illustrative embodiments of the invention.

FIG. 9 schematically shows a user selecting a different type of cabinet in accordance with illustrative embodiments of the invention.

FIG. 10 schematically shows an updated shopping cart after a second available cabinet is added to cart in accordance with illustrative embodiments of the invention.

FIG. 11A shows a screenshot of two varieties of shopping carts in accordance with illustrative embodiments of the invention.

FIG. 11B shows a screenshot of another variety of a shopping cart in accordance with illustrative embodiments of the invention.

### DESCRIPTION OF ILLUSTRATIVE EMBODIMENTS

As mentioned above, online shopping for kitchen cabinets is confusing for many customers because of the different types, functions, sizes, and styles of cabinets. For one thing, it is difficult to determine which cabinets are appropriate for a particular home kitchen. Also, online cabinet shopping sites typically operate using a traditional paradigm of presenting a 2D or 3D model (e.g., of a kitchen with cabinets) on a first web page and then requiring navigation to a second web page for user selection of a particular cabinet and even requiring navigation to a third web page for a “shopping cart” of selected cabinets. Such switching between web pages can make it difficult for the user to keep track of which cabinets have been selected and details of those cabinets (e.g., style, dimensions, etc.), which in turn can make it difficult for the user to continue selection of cabinets to match and fit with already selected cabinets.

Therefore, illustrative embodiments provide an improved graphical user interface for shopping for cabinets online in which shopping is conducted through a single web page from which the user can view a displayed 3D interactive cabinet layout, select and view cabinet styles, select cabinets within the displayed layout in order to view cabinet options of a selected cabinet style for purchase, select cabinets from the displayed options, and view a list of selected cabinets in a “shopping cart”. In this way, all relevant information is accessible through this single web page such that the user does not have to navigate through different web pages in order to view and keep track of cabinets and cabinet selections.

Specifically, a graphical user interface displays an interactive 3D model of a cabinet layout (e.g., for a kitchen) with different types of selectable cabinets and different styles of cabinets. In response to a selection of a particular cabinet type and a particular cabinet style, a list of appropriate cabinets of various sizes that correspond to the type and style of the selected cabinet are populated in the interface. As the user adds the selected cabinet to their shopping cart, a shopping cart window is displayed in the graphical user interface. The cart window is continuously updated as the user adds or removed cabinets within the window of the 3D model, advantageously allowing the user to see what cabinets they have already added to their cart while simultaneously viewing the 3D model. Details of illustrative embodiments are discussed below.

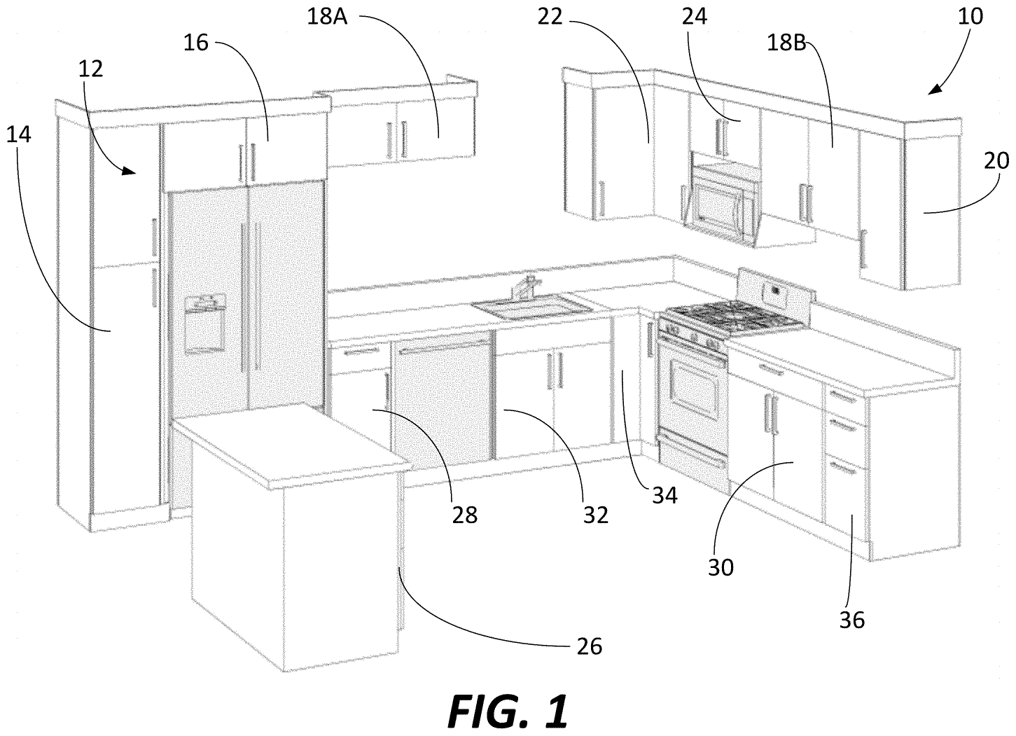

FIG. 1 shows an example of a kitchen 10 in accordance with illustrative embodiments of the invention. Like many kitchens, the kitchen 10 may have a refrigerator, a stove, a microwave, a sink, a dishwasher, countertops, wall moldings, a kitchen island, a ventilation hood (not shown), and a plurality of cabinets, among other things. While the cabinets in FIG. 1 may all look similar, and indeed, are preferably of the same style, the various cabinets are of different types and serve different functions.

For example, FIG. 1 shows a variety of different types of cabinets, including: tall cabinets 14 (i.e., next to the refrigerator), refrigerator cabinets 16 (i.e., above the refrigerator), two-door wall cabinets 18A and 18B of different sizes, one-door wall cabinets 20, wall corner cabinets 22, microwave cabinets 24, island cabinets 26, one-door base cabinets 28, two-door base cabinets 30, sink cabinets 32, base corner cabinets 34, and drawer base cabinets 36. While this is a relatively large list, it is not exhaustive, and other types of cabinets are envisioned as being within the scope of illustrative embodiments. Adding to the variety of types of cabinets, the various types come with their own varieties (e.g., one-door vs. two-door) and sizing.

When remodeling the kitchen 10, frequently the size for each of the various types of the cabinets is pre-determined because the kitchen 10 has layout has already been built. It can be confusing for customers, when shopping online, to determine what type and size of cabinet they need for their home remodeling project. Generally, customers are required to visit a kitchen remodeling retailer and are guided through the kitchen remodeling process by a technician.

Illustrative embodiments advantageously allow the user to select the cabinet style and cabinet type in a graphical user interface and provide the user with a list of appropriate and selectable cabinets. As the user adds cabinets to their online shopping cart, the shopping cart is displayed in the same window as the 3D model, allowing the user to continue shopping while keeping an actively populated and visible cart.

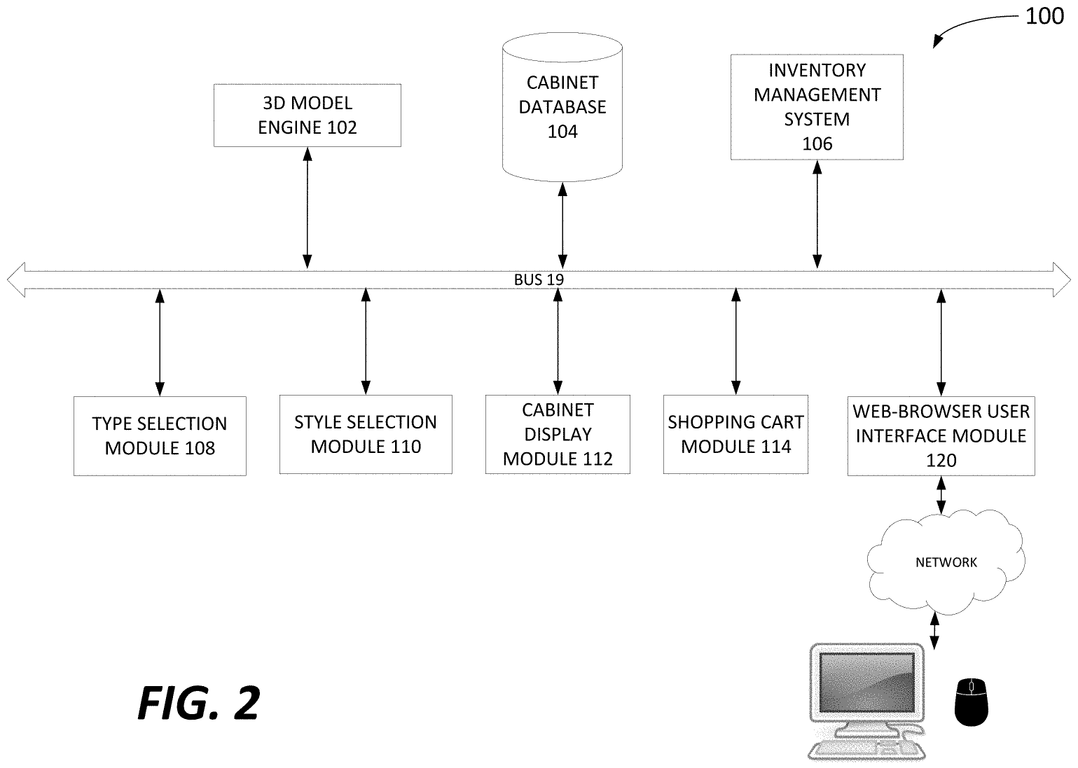

FIG. 2 schematically shows a system 100 configured to generate an online web-browser enabled interactive graphical user interface for simplifying online shopping for kitchen cabinets, in accordance with illustrative embodiments of the invention.

The system 100 includes a 3D model engine 102 configured to generate a 3D model of the kitchen 10. The 3D model engine 102 communicates with a web-browser user interface module 120 to display the 3D model in the user interface. In various embodiments, the 3D model engine 102 may generate the 3D kitchen 10 based on a picture or layout of the customers kitchen 10. However, in some other embodiments, the 3D model of the kitchen 10 may be pre-defined, and may be, for example, the model of the kitchen 10 provided in FIG. 1. The 3D model is displayed in the user interface (e.g., of a web-browser), and includes a variety of types of kitchen cabinets (e.g., cabinets 14-34) that are selectable by a user input within the user interface in the web browser (e.g., by a computer mouse). For convenience, the various types of cabinets (e.g., including the cabinets 14-34 described above) are simply referred to as cabinets 12.

The system 100 also includes a cabinet database 104 configured to hold data relating to a plurality of types and styles of the kitchen cabinets 12. Specifically, the database 104 contains information relating to the style, the type, and the size of various kitchen cabinets 12. Furthermore, the database 104 may communicate with an inventory management system 106. The inventory management system 106 tracks the quantity and availability of the various cabinets 12. Accordingly, the database 104 may receive information relating to whether various cabinets 12 are in stock and/or available.

The system 100 includes a style selection module 110 configured to receive a selection of a style of the cabinet 12 from the user (e.g., in the web-browser). The style of cabinet 12 may be selected from a list, or from a graphical representation of various styles of cabinets 12 (e.g., by a user input on a graphical representation of a particular style of cabinet 12). The user interface module 120 is configured to display the 3D model and the style selection graphical representation within a single web-browser.

The system 100 includes a type selection module 108 configured to receive a selection of a type of cabinet 12 from the user (e.g., in the web-browser). The type selection module 108 communicates with the 3D model engine 102 to make the 3D model interactive. Specifically, various parts of the 3D model are associated with a particular type of cabinet 12. The type selection module 108 receives the selection from a user (e.g., by a user input on a graphical representation of a particular type of cabinet 12 in the 3D model). The particular type that is selected from the 3D model is determined by the type selection module 108, by associating various parts of the 3D model with types of cabinets 12 that are available in the database 104.

A cabinet selection module 112 receives the type and style selection for the cabinets 12, from the type selection module 108 and the style selection module 110, respectively. The cabinet selection module 112 also communicates with the database 104 to generate a list of available cabinet 12 sizes that correspond to the selected style and type. In illustrative embodiments, the cabinet display module 112 generates a graphical representation for each of the various available sizes that match the style and type of the cabinet 12. The user interface module 120 is configured to display the graphical representation for each of the various available sizes that match the style and type of the cabinet within the single web-browser interface along with the 3D model.

A shopping cart module 114 is configured to receive a selection of a style, type, and size of the cabinet 12, and to generate a shopping cart within the web-browser that shows the 3D model. The web-browser user interface module 120 provides the user interface to a web-browser enabled computing device, within the same web-browser as the cabinet 12 style selection, the type selection, and the size selection.

In various embodiments, the user interface module 120 may be configured to generate an interface on a web browser (e.g., a browser, such as the Internet Explorer browser developed by Microsoft Corporation of Redmond, Wash.), a native application (e.g., an application supported by an operating system of the device (e.g., one of client machine(s) 110), such as Android, Windows, or iOS), or other application.

Each of the above-described components is operatively connected by any conventional interconnect mechanism. FIG. 2 simply shows a bus 19 communicating each of the components. Those skilled in the art should understand that this generalized representation can be modified to include other conventional direct or indirect connections. Accordingly, discussion of a bus is not intended to limit various embodiments.

Indeed, it should be noted that FIG. 2 only schematically shows each of these components. Those skilled in the art should understand that each of these components can be implemented in a variety of conventional manners, such as by using hardware, software, or a combination of hardware and software, across one or more other functional components. For example, the inventory management system 106 may be implemented using a plurality of microprocessors executing firmware. As another example, the 3D model engine 102 may be implemented using one or more application specific integrated circuits (i.e., “ASICs”) and related software, or a combination of ASICs, discrete electronic components (e.g., transistors), and microprocessors. Accordingly, the representation of the various modules within a single box is for simplicity purposes only.

In fact, in some embodiments, user interface module 120 of FIG. 2 is distributed across a plurality of different machines—not necessarily within the same housing or chassis. Additionally, in some embodiments, components shown as separate (such as the type selection module 108, the style selection module 110, and the cabinet display module 112 in FIG. 2) may be replaced by a single component. Furthermore, certain components and sub-components in FIG. 2 are optional. For example, some embodiments may not use the inventory management system 106.

It should be reiterated that the representation of FIG. 2 is a significantly simplified representation of an actual system 100 for generating a web-browser enabled user interface for selecting kitchen cabinets. Those skilled in the art should understand that such a device may have other physical and functional components, such as central processing units, other packet processing modules, and short-term memory. Accordingly, this discussion is not intended to suggest that FIG. 2 represents all of the elements of the system 100.

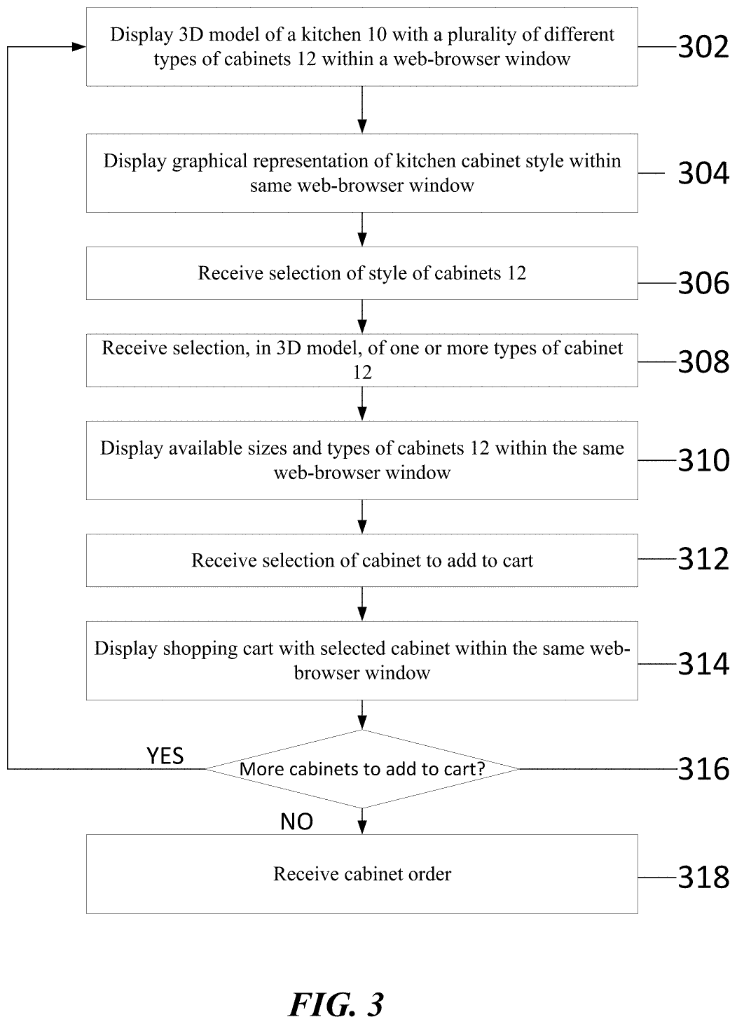

FIG. 3 shows a process of generating an interactive web-browser enabled user interface for selecting and purchasing kitchen cabinets 12 using a 3D model in accordance with illustrative embodiments of the invention. Prior to the introduction of various embodiments of the process and system described herein, it was impossible to quickly visualize and ensure purchasing appropriate kitchen cabinets 12 of a particular size, type, and style. Specifically, the user may click on a particular type of cabinet within the 3D model of the kitchen 10. In the same graphical user interface, a list of cabinets of various sizes, of the selected type, and in some embodiments the selected style, are populated in a list. The user may choose a selection, from the populated list, and add the selection to the shopping cart. Rather than moving to a separate shopping cart, the cart is advantageously populated within the graphical user interface. Furthermore the user interface is adjusted in real-time as additions or removals are made from the cart. Accordingly, customers may compare the contents of their cart relative to the 3D model as they shop for kitchen cabinets. This advantageously reduces the difficulty associated with determining which type of cabinet has already been selected, and which style of cabinet needs to be selected to complete the user's desired kitchen remodeling.

It should be noted that this process can be a simplified version of a more complex process of FIG. 3 shows a process 300 of generating an interactive web-browser enabled user interface for selecting and purchasing kitchen cabinets from a 3D model in accordance with illustrative embodiments of the invention. As such, the process may have additional steps that are not discussed. In addition, some steps may be optional, performed in a different order, or in parallel with each other. Accordingly, discussion of this process is illustrative and not intended to limit various embodiments of the invention.

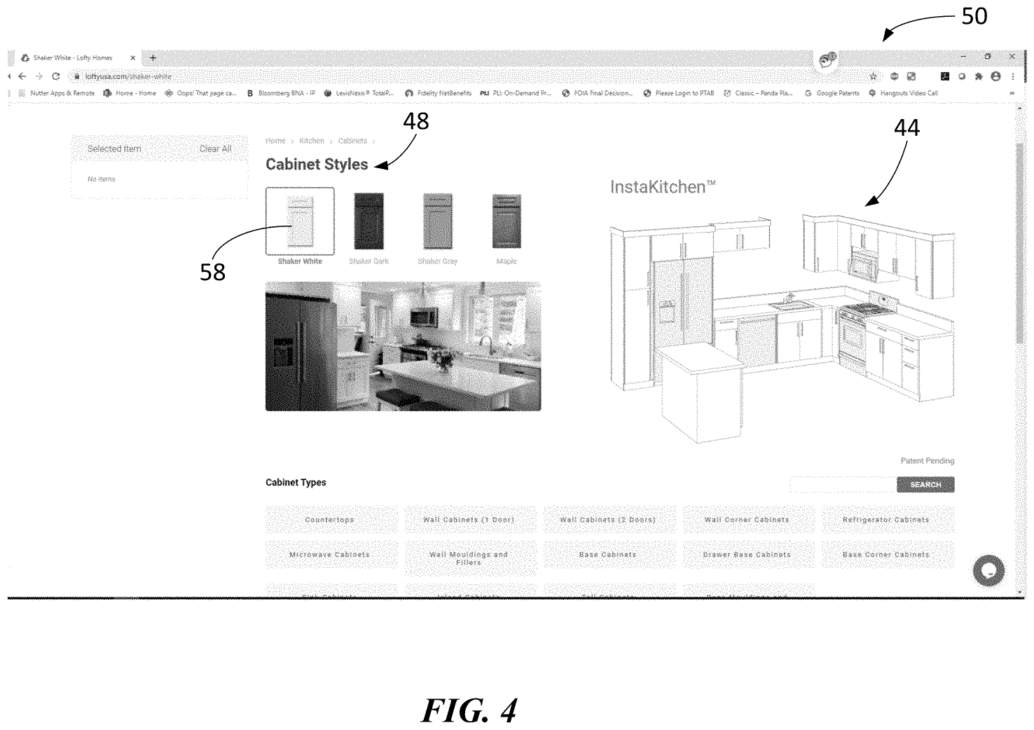

The process 300 of FIG. 3 begins at step 302, which displays the 3D model 44 of a kitchen 10 with a plurality of different types of cabinets 12 within a web-browser window 50. FIG. 4 schematically shows the 3D model 44 of the kitchen 10 within the web-browser window 50. To that end, the 3D model engine 102 may be used to display the kitchen 10. FIG. 4 shows a screenshot of the web-browser window 50 user interface including the 3D model 44 in accordance with illustrative embodiments of the invention. It should be understood that the 3D model 44 shown is not intended to limit illustrative embodiments. In various embodiments, the 3D model 44 includes graphical representations of different types of cabinets 12 that are selectable. However, various embodiments are not intended to be limited by the type of cabinets 12 shown herein.

The process then proceeds to step 304, which displays a graphical representation of selectable kitchen cabinet style 48 within same web-browser window 50 as the 3D model 44. The four styles 48 shown include: shaker white, shaker dark, shaker gray, and maple. It should be understood that these four styles 48 are not intended to limit illustrative embodiments. Instead, these four styles 48 are provided merely as examples for discussion. Illustrative embodiments may have more or fewer styles. Additionally, or alternatively, illustrative embodiments may include entirely different styles than shown in FIG. 4.

Although step 304 is shown and described as coming after step 302, it should be understood that these steps may occur simultaneously, and in some embodiments, step 304 may come before step 302.

Returning to the process shown in FIG. 3, step 306 receives the selection of the style 48 of the cabinet 12 within the web-browser 50 (e.g., by the user input selecting a graphical representation of a particular style 48). FIG. 4 shows that the “shaker white” style 48 is selected. In various embodiments, the style 48 is chosen by selecting the visual representation 58 (e.g., picture 58).

In particular, as the user makes their selection in the 3D model, the web-browser user interface module 120 registers the selection and communicates with the style selection module 110. The style selection module 110 determines the selected style 48 based on the user selection, and communicates this information to the cabinet database 104 to be used at a later step.

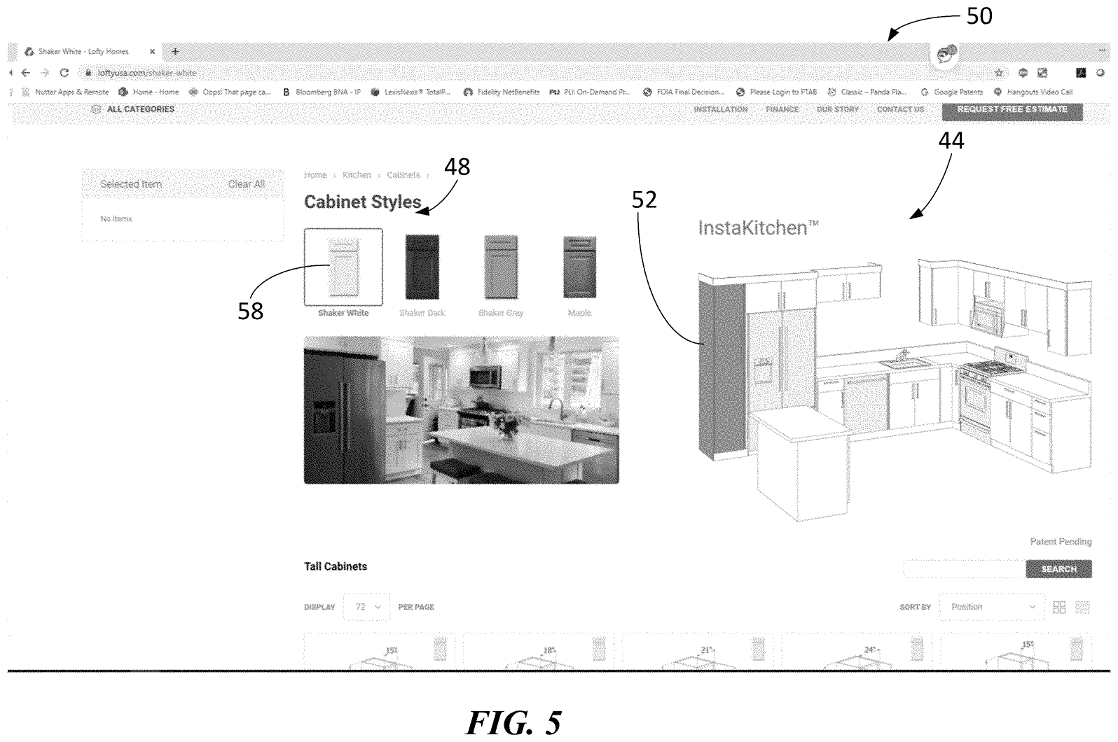

At step 308, the process receives a selection, in the 3D model 44 within the web-browser 50, of a selected type 52 of cabinet 12. It should be noted that in illustrative embodiments, the 3D model 44 is displayed within the same web-browser window 50 as the style selection graphical interface. FIG. 5 schematically shows the selected type 52 highlighted within the web-browser window 50 in accordance with illustrative embodiments of the invention.

The web-browser user interface module 120 receives the selection of the type 52 of cabinet 12 and registers the selection. The selection is communicated to the type selection module 108, which determines the selected type 52 based on the user selection, and communicates this information to the cabinet database 104 to be used at a later step.

While preferred embodiments receive the selection from the 3D model 44 (e.g., by clicking directly on the cabinet in the model 44), some embodiments may receive a selection that is not directly from a user input in the model 44. For example, some embodiments may receive a selection from a list of various types 52 of cabinets 12 (e.g., adjacent to the model). Furthermore, the external selection (not directly from the model 44) may cause a corresponding visual emphasis in the model. For example, a selection of a type 52 of cabinet 12 from an external list may cause the corresponding selected type 52 of cabinet 12 in the model 44 to become highlighted.

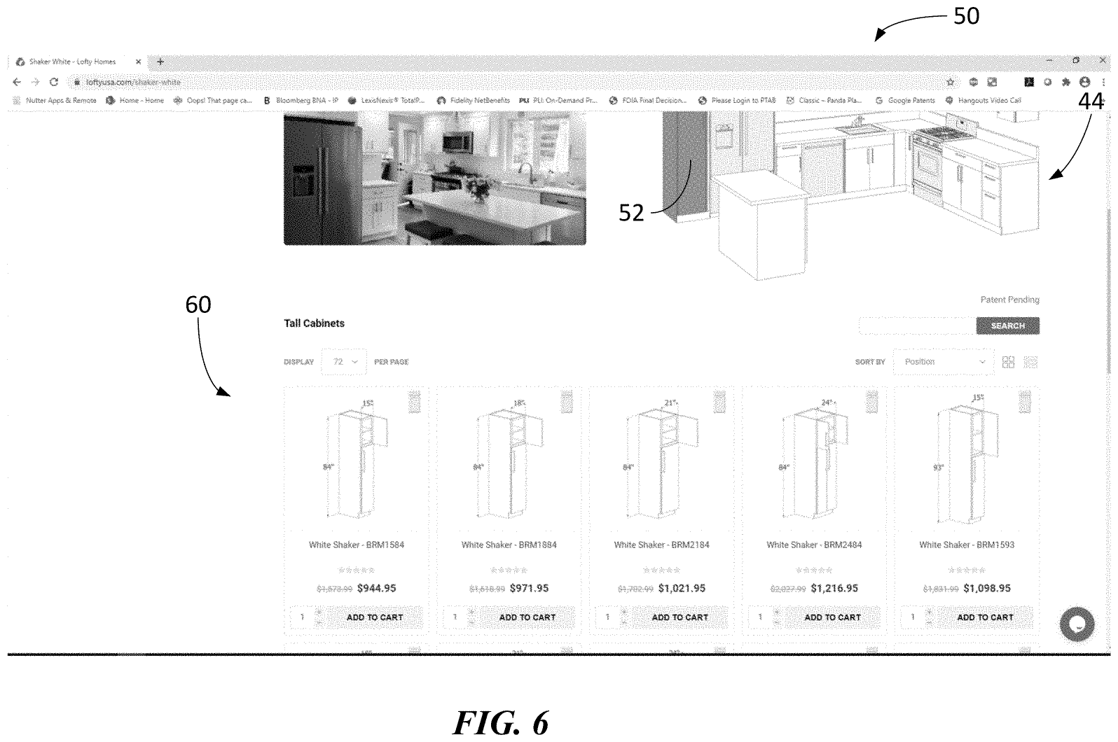

At step 310 the process displays available cabinets 60 based on the selected style 48 and type 52 from steps 306 and 308 within the same web-browser window 50. FIG. 6 schematically shows the available cabinets 60 shown graphically within the same web-browser 50 display 50 of FIG. 5 in accordance with illustrative embodiments of the invention. In illustrative embodiments, as the style 48 or type 52 of cabinet 12 is changed by selection in the user interface, the user interface module 120 communicates with the cabinet database 104 and/or inventory management system 106 to determine the corresponding available cabinets 60 to display.

The cabinet display module 112 receives the selection of the style 48 and type 52 from the type selection module 108 and the style selection module 110, respectively. The cabinet display module 112 displays all of the available cabinets 60 that meet the received style and type settings. For example, the cabinet display module 112 may communicate with the cabinet database 104 to obtain the available cabinets 60, and list and/or show a graphical representation of the associated available cabinets 60 via the user interface module 120. The cabinet display module 112 may show cabinets 12 that match the style and type, with a variety of sizes, varying numbers of drawers (if appropriate), and/or varying numbers of doors (if appropriate).

The cabinet display module 112 generates images for available cabinets in FIG. 6 (in this example, five cabinets 60 are visible). However, it should be understood that more available cabinets 60 may be seen scrolling down in the browser window 50. The five available cabinets 60 all match the type 52 (e.g., tall cabinet) and the style 48 (e.g., shaker white) selected in previous examples. However, as shown, each of the available cabinets 60 have different dimensions. Additionally, or alternatively, each of the cabinets may have a different number of doors and/or drawers. Users may see the available cabinets 60, and select the cabinet 60 that meets the dimensions and desires of their home kitchen.

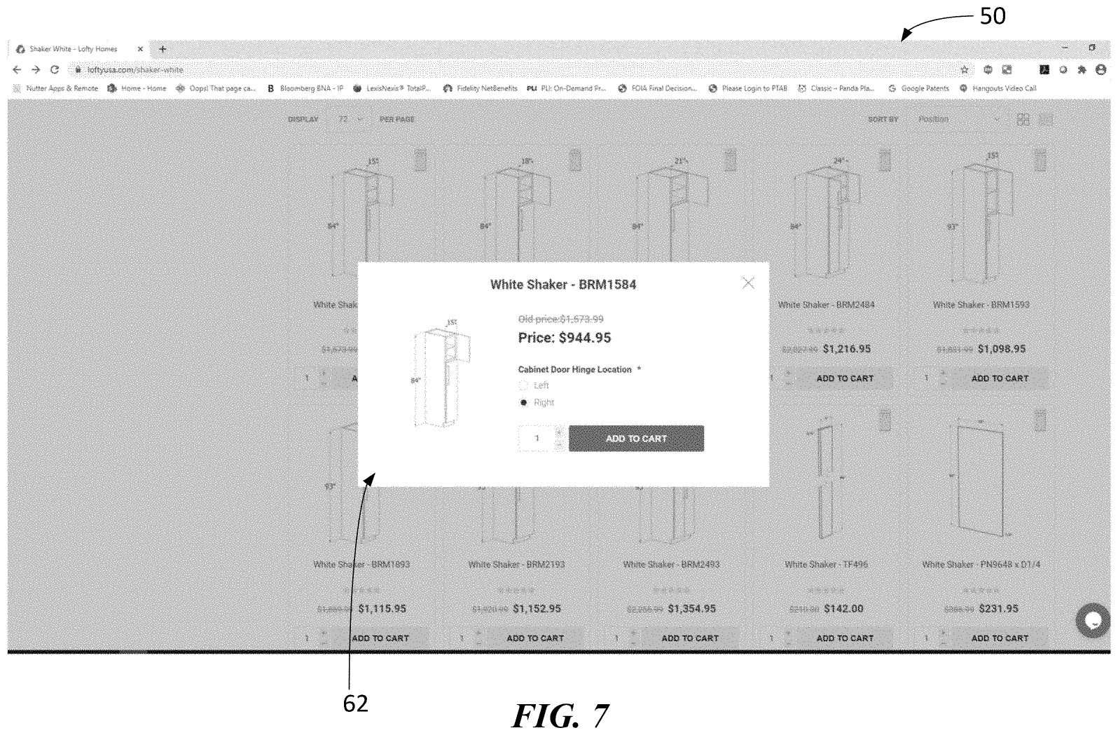

The process then proceeds to step 312, which receives a selection of an available cabinet 60 to add to the cart. FIG. 7 schematically shows an example of adding one of the available cabinets 60 to the cart in accordance with illustrative embodiments of the invention. FIG. 7 schematically shows an overlay 62 that appears after the user click the “add to cart” button beneath any of the graphical representations of available cabinets 60 in FIG. 6. The overlay 62 may include a graphical representation of the selected available cabinet 60, as well as additional information (e.g., price, quantity, model number, cabinet door hinge location, etc.). The user may then add the selected cabinet 60 to the cart 70.

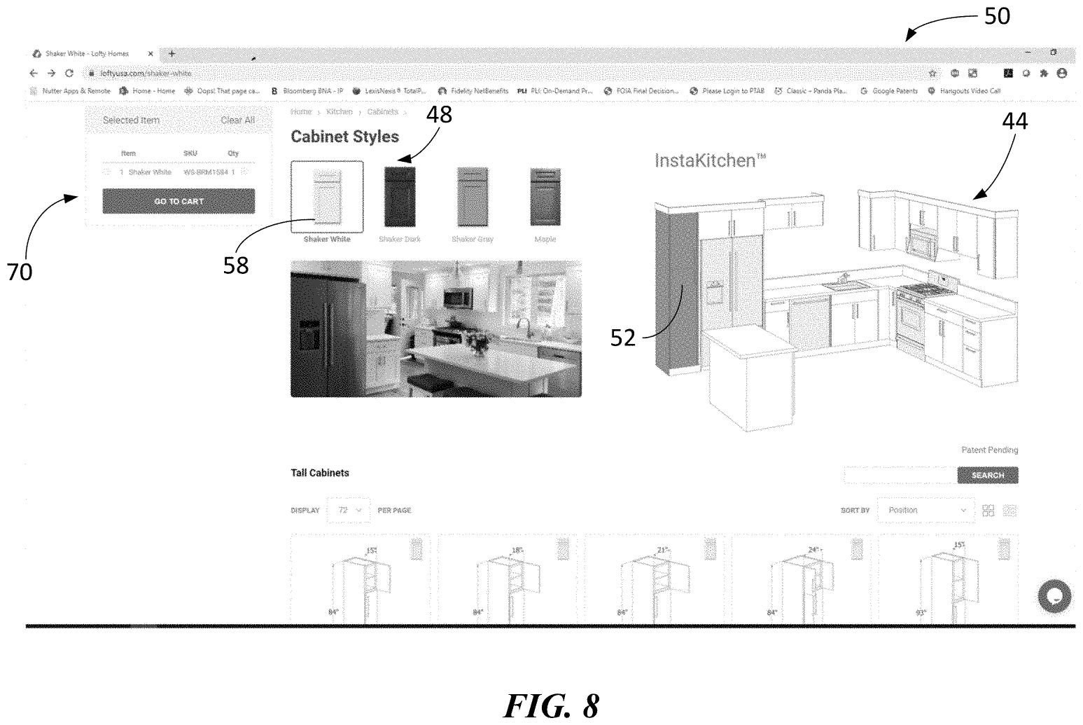

At step 314, the system 100 displays the shopping cart 70 with the selected available cabinet 60 that was added to the cart 70 in step 312. FIG. 8 schematically shows the shopping cart 70 in the same web-browser 50 user interface of FIG. 5 in accordance with illustrative embodiments of the invention. Specifically, the shopping cart 70 is in the same window 50 as the 3D model 44, and the cabinet style graphical representation 58 of FIG. 5. Populating and updating the shopping cart 70 on the same page as the model 44 advantageously provides an easier shopping experience over prior art shopping carts that are presented in an overlay or on an entirely different page.

The user is thus able to easily visualize the cabinet 12 quantity and other related information as they continue to shop for cabinets 12. Accordingly, the process proceeds to step 316, which determines whether there are more cabinets 12 to add to the cart. If there are more cabinets, then the process returns to step 302, which displays the 3D model. However, in this instance, the updated shopping cart 70 reflecting the selected available cabinet 60 is also in the same window 50.

Many of the steps 302-314 have already been described, and therefore, are not described here again. However, some additional examples of how the process repeats itself are provided here for clarity.

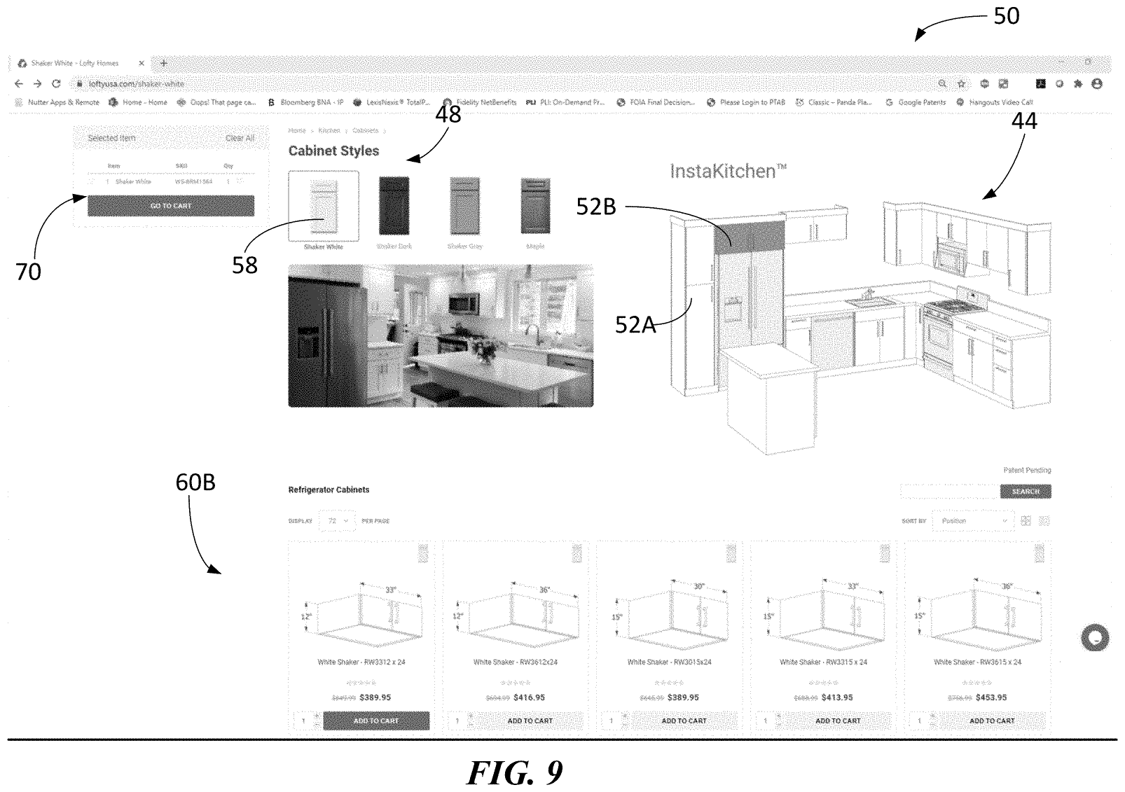

FIG. 9 schematically shows a user selecting a different type 52B of cabinet 12 in accordance with illustrative embodiments of the invention. This cabinet type 52B is different from the cabinet type 52A that was selected previously. As shown, the 3D model 44 is in the same web-browser display 50 as the pending shopping cart 70, the graphical representation 58 of the style 48, as well as the cabinets that correspond to the selected type (e.g., refrigerator) and the selected style (e.g., shaker white).

The available cabinets 60B that correspond to type 52B and (e.g., refrigerator cabinet) and style 48 (e.g., shaker white) are displayed in the same web-browser window 50 as the shopping cart 70 and the 3D model 44. Conveniently, as described previously, the user may review the various available cabinets and add to cart.

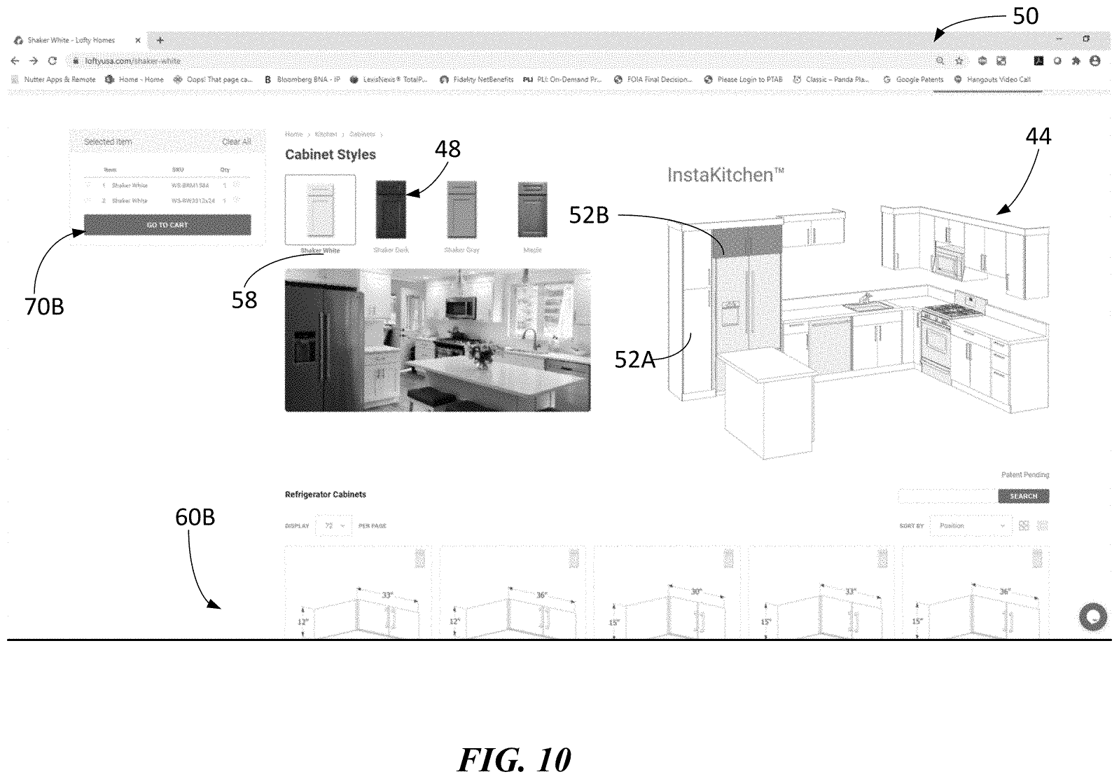

FIG. 10 schematically shows an updated shopping cart 70B after a second available cabinet 60B is added to cart in accordance with illustrative embodiments of the invention. As shown, the updated shopping cart 70B reflects the changed to the cart. It should be understood that items may be removed from the shopping cart 70 (e.g., the user interface module 120 presents a selectable “x” button to remove the cabinet 12) and that those changes are reflect in real-time in the shopping cart. Additionally, if more cabinets 12 are to be purchased, the process 300 may be repeated. In such instances, the user may continue to select the style 48 and the type 52 of cabinet 12, view available cabinets 60, and then add them to the shopping cart 70 in real-time.

The process returns to step 316. If there are no more cabinets to add to the cart, then the process proceeds to step 318, where the system 100 receives the cabinet 12 order based on the cabinets identified in the shopping cart 70. The system 18 compares the properties of the selected cabinet 62 to identify available options from the database. The order is sent to the fulfillment system, and the inventory management system 106 and/or the cabinet database 104 are updated to reflect the reduced quantity of the ordered cabinets 12.

As described previously, it is envisioned that illustrative embodiments may interact with a large variety of cabinets, and therefore, are not limited to those shown in the figures. Although the above process is described with reference to adding a single cabinet 46, it should be understood that the process may be expanded to cover viewing and adding a plurality of cabinets 12.

It should be noted that the system can be configured to highlight items listed in the shopping cart 70 in the 3D model 44 (e.g., using a specific color) so that the user can easily identify which cabinets already have been added to the shopping cart and which still remain to be added to the shopping cart.

It should be noted that available cabinet options presented to the user (such as available cabinets 60 in FIG. 6 and available cabinets 60B in FIG. 9) can be chosen and/or arranged (e.g., filtered or ordered) by the system based on items already listed in the shopping cart 70. For example, with reference again to FIG. 9, the refrigerator cabinet options 60B presented to the user when the user selects cabinet 52B could be chosen and/or arranged by the system based on the dimensions of the tall cabinet 52A that is already in the cart, e.g., presenting refrigerator cabinet options of the same depth as the tall cabinet and/or presenting refrigerator cabinet options based on the height of the tall cabinet (e.g., if the user selected a tall cabinet having a height of 84 inches as in the figures, then the system might prioritize refrigerator cabinets having a height of 12 inches so that there will be sufficient room under the refrigerator cabinet for a standard height refrigerator, but if the user selected a tall cabinet having a height of 93 inches, then the system might prioritize refrigerator cabinets having a height of 15 inches because a taller refrigerator cabinet can be accommodated). As the user continues to select cabinets, the system can continue choosing available cabinet options in this way, e.g., prioritizing taller wall cabinets for use with the 93 inch tall cabinet.

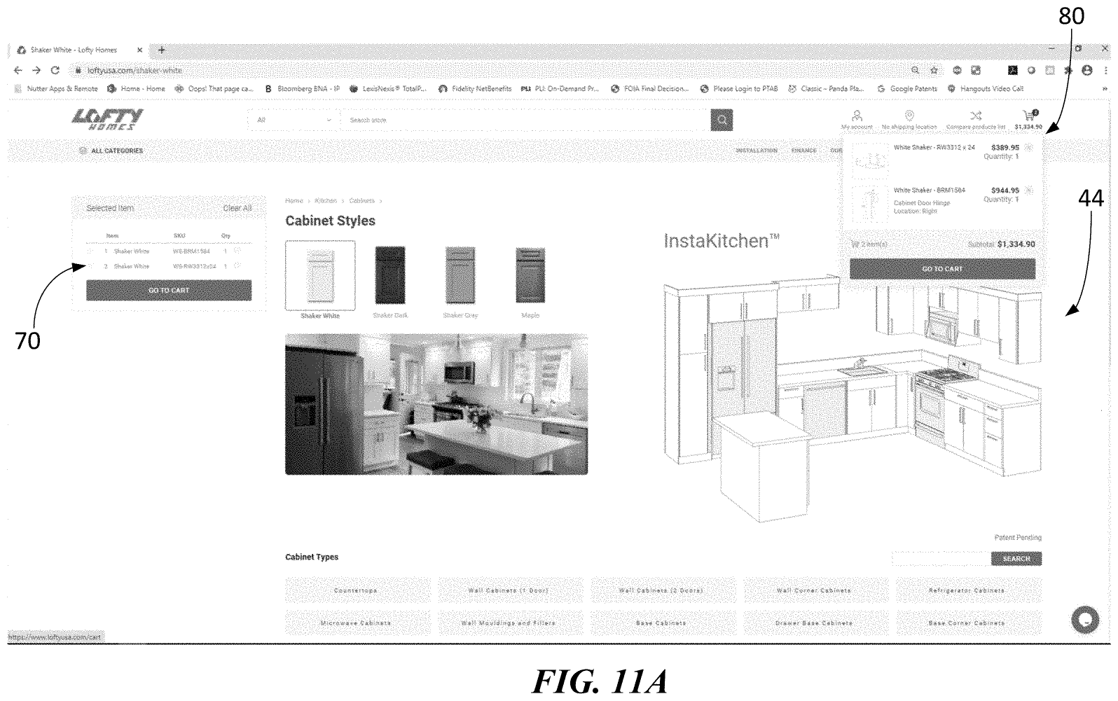

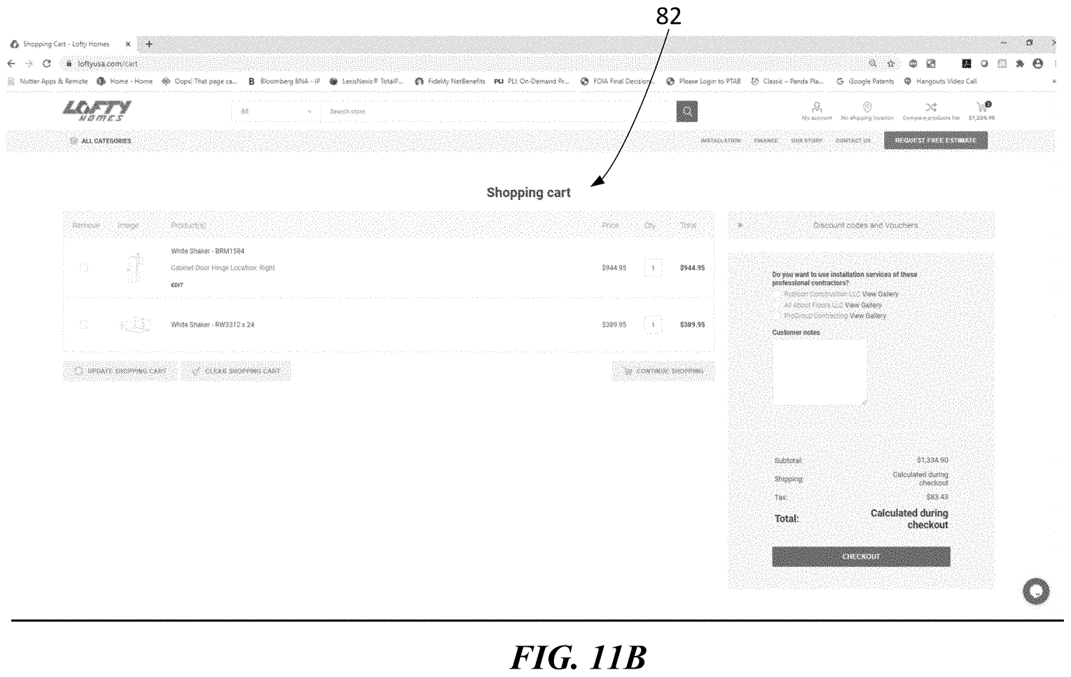

FIG. 11A shows a screenshot of two varieties of shopping carts 70 and 80 in accordance with illustrative embodiments of the invention. The real-time updated shopping cart 70 in the same web page as the 3D model 44. Additionally, a shopping cart button may be clicked to display a shopping cart overlay 80 in the window. FIG. 11B shows a screenshot of another variety of a shopping cart 82 in accordance with illustrative embodiments of the invention. The shopping cart 82 is shown in the web page but on a different page from the 3D model 44. Preferred embodiments provide the shopping cart 70 in the same web-browser page as the 3D model 44.

It should be readily apparent to one of skill in the art that illustrative embodiments provide improvements in the functioning of a computer. As mentioned previously, prior art methods involved manually identifying SKU numbers for cabinets 12 and determining which cabinets corresponded to the appropriate type. In contrast, illustrative embodiments advantageously allow for selecting of the type of cabinet needed, and available cabinets are displayed for selection by the user. This provides an entirely new way of shopping for cabinets. Advantageously, users may now confirm that they are selecting the appropriate type of cabinet by using a 3D model to assist with purchasing, and also keep track of their shopping cart in real time. Accordingly, illustrative embodiments provide improved efficiency and accuracy for computer design programs.

By providing a user interface that allows adding to cart and maintaining the shopping cart 70 on the same page/window 50 provides a considerably more intuitive and better shopping experience. Customers are able to view what cabinets they are adding to their shopping cart 70 in real time. This helps customers make sense of their shopping cart (particularly as large numbers of cabinets 12 added, which may produce customer anxiety).

It should be further understood that although illustrative embodiments refer to an e-commerce system for kitchen cabinets, that the 3D model may relate to more than kitchen cabinets. For example, illustrative embodiments may include a 3D model with selectable backsplash, functional accessories, microwave ovens, hoods, ovens, sinks, refrigerators, and/or countertops, among other things. Additionally, it should be understood that the e-commerce system described in various embodiments may be used for shopping generally outside the realm of cabinets.

For example, some embodiments provide a 3D model having a plurality of different types of items that are selectable by a user from the 3D model in a web page. A selection of a type of item may display available items that correspond to the selected item type in the web page. Furthermore, the user may select in the web-browser user interface one of the available item options to add to a shopping cart. Illustrative embodiments may further display a shopping cart having the selected item, along with the interactive 3D model, in the web-browser user interface. A second or additional selection of a second item type may be received by a user from the 3D model. In a similar manner as described above, additional items may be added to the shopping cart in the web-browser. The selected item types may include, for example, different types of cabinets, appliances, furniture, etc. The interactive 3D model would also have a corresponding display of the items (e.g., furniture may be selectable in a 3D model of a living room).

Various embodiments of the invention may be implemented at least in part in any conventional computer programming language. For example, some embodiments may be implemented in a procedural programming language (e.g., “C”), as a visual programming process, or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the methods described above) may be implemented as a computer program product for use with a computer system. Such implementation may include a series of computer instructions fixed either on a tangible, non-transitory, non-transient medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A computer-implemented method for providing a user interface for selecting cabinets in a system having a server in communication with an internet-coupled user computing device over a first network that includes the internet, the method comprising:
serving a web page to the internet-coupled user computing device displaying a web-browser user interface with an interactive 3D model of a cabinet layout, the 3D model including a plurality of different cabinet types, each of the plurality of different cabinet types being selectable by the user from the interactive 3D model;
receiving a selection of a cabinet type from a user, wherein the selection is made by the user selecting the graphical representation of the cabinet type from the interactive 3D model;
serving an updated version of the web page displaying available cabinet options along with the interactive 3D model in the web-browser user interface, the available cabinet options being associated with the selection of the cabinet type;
receiving a selection, in the web-browser user interface, of one of the available cabinet options to add to a shopping cart, the selection defining a selected cabinet; and
serving an updated version of the web page displaying the shopping cart along with the interactive 3D model in the web-browser user interface, the shopping cart including the selected cabinet.

2. The computer-implemented method of claim 1, the method further comprising:
receiving a second selection of a second cabinet type from the user, wherein the selection is made by the user selecting the graphical representation of the second cabinet type from the interactive 3D model;
serving an updated version of the web page displaying available cabinet options in the web-browser user interface, the available cabinet options being associated with the second selection;
receiving a selection, in the web-browser, of one of the available cabinet options to add to the shopping cart, the selection defining a second selected cabinet;
serving an updated version of the web page displaying an updated shopping cart, in the web-browser user interface, that includes the second selected cabinet.

3. The computer-implemented method of claim 1, further comprising:
serving an updated version of the web page displaying the web-browser user interface with a pictorial representation of a plurality of cabinet styles, each of the plurality of different cabinet styles being selectable.

4. The computer-implemented method of claim 3, further comprising:
receiving a selection of a cabinet style from a user, wherein the selection is made by the user selecting the pictorial representation of the cabinet style from the web-browser user interface.

5. The computer-implemented method of claim 4, further comprising:
displaying the available cabinet options in the web-browser user interface, the available cabinet options being associated with the selection of the cabinet type and the cabinet style.

6. The computer-implemented method of claim 1, wherein the interactive 3D model includes tall cabinets, refrigerator cabinets, wall cabinets, corner cabinets, microwave cabinets, island cabinets, base cabinets, and sink cabinets.

7. The computer-implemented method of claim 1, wherein the available cabinet options that are associated with the selection of the cabinet type include a variety of cabinet sizes.

8. The computer-implemented method of claim 1, further comprising serving an updated version of the web page displaying a second shopping cart as an overlay.

9. A system for shopping for cabinets, the system comprising:
a 3D model engine configured to generate a 3D model of a kitchen including a plurality of cabinet types;
a web-browser user interface module configured to serve a web page with the interactive 3D model including the plurality of different cabinet types, each of the plurality of different cabinet types being selectable by a user from the interactive 3D model;
a type selection module configured to receive a selection of a cabinet type from the user, wherein the selection is made by the user selecting the graphical representation of the cabinet type from the interactive 3D model;
a cabinet display module configured to serve an updated version of the web page displaying available cabinet options along with the interactive 3D model in the web-browser user interface, the available cabinet options being associated with the selection of the cabinet type;
a shopping cart module configured to generate a shopping cart within the web page as a function of receiving a selection, in the web-browser user interface, of one of the available cabinet options to add to a shopping cart, the selection defining a selected cabinet; and
the web-browser user interface module further configured to serve an updated version of the web page displaying the shopping cart along with the interactive 3D model in the web-browser user interface, the shopping cart including the selected cabinet.

10. The system of claim 9, wherein:
the type selection module is further configured to receive a second selection of a second cabinet type from the user, wherein the selection is made by the user selecting the graphical representation of the second cabinet type from the interactive 3D model;
the web-browser user interface module is further configured to serve an updated version of the web page displaying available cabinet options in the web-browser user interface, the available cabinet options being associated with the second selection;
the shopping cart module further configured to generate an updated shopping cart within the web page as a function of receiving a selection, in the web-browser, of one of the available cabinet options to add to the shopping cart, the selection defining a second selected cabinet;
the web-browser user interface module further configured to serve an updated version of the web page displaying an updated shopping cart, in the web-browser user interface, that includes the second selected cabinet.

11. The system of claim 9, further comprising:
a style selection module configured to display a pictorial representation of a plurality of cabinet styles within the web page, each of the plurality of different cabinet styles being selectable.

12. The system of claim 11, wherein the style selection module is configured to receive a selection of a cabinet style from the user, wherein the selection is made by the user selecting the pictorial representation of the cabinet style from the web-browser user interface.

13. The system claim 12, wherein the web-browser user interface module further configured to serve an updated version of the web page to display the available cabinet options in the web-browser user interface, the available cabinet options being associated with the selection of the cabinet type and the cabinet style.

14. The system of claim 9, wherein the interactive 3D model includes tall cabinets, refrigerator cabinets, wall cabinets, corner cabinets, microwave cabinets, island cabinets, base cabinets, and sink cabinets.

15. A computer program product for use on a computer system for selecting cabinets in a three-dimensional model, the computer program product comprising a tangible, non-transient computer usable medium having computer readable program code thereon, the computer readable program code comprising:
program code for serving a web page to the internet-coupled user computing device displaying a web-browser user interface with an interactive 3D model of a cabinet layout, the 3D model including a plurality of different cabinet types, each of the plurality of different cabinet types being selectable by the user from the interactive 3D model;
program code for receiving a selection of a cabinet type from a user, wherein the selection is made by the user selecting the graphical representation of the cabinet type from the interactive 3D model;
program code for serving an updated version of the web page displaying available cabinet options along with the interactive 3D model in the web-browser user interface, the available cabinet options being associated with the selection of the cabinet type;
program code for receiving a selection, in the web-browser user interface, of one of the available cabinet options to add to a shopping cart, the selection defining a selected cabinet; and
program code for serving an updated version of the web page displaying the shopping cart along with the interactive 3D model in the web-browser user interface, the shopping cart including the selected cabinet.

16. The computer program product of claim 15, the method further comprising:
program code for receiving a second selection of a second cabinet type from the user, wherein the selection is made by the user selecting the graphical representation of the second cabinet type from the interactive 3D model;
program code for serving an updated version of the web page displaying available cabinet options in the web-browser user interface, the available cabinet options being associated with the second selection;
program code for receiving a selection, in the web-browser, of one of the available cabinet options to add to the shopping cart, the selection defining a second selected cabinet;
program code for serving an updated version of the web page displaying an updated shopping cart, in the web-browser user interface, that includes the second selected cabinet.

17. The computer program product of claim 15, further comprising:
program code for serving an updated version of the web page displaying the web-browser user interface with a pictorial representation of a plurality of cabinet styles, each of the plurality of different cabinet styles being selectable.

18. The computer program product of claim 17, further comprising:
program code for receiving a selection of a cabinet style from a user, wherein the selection is made by the user selecting the pictorial representation of the cabinet style from the web-browser user interface.

19. The computer program product of claim 18, further comprising:
program code for displaying the available cabinet options in the web-browser user interface, the available cabinet options being associated with the selection of the cabinet type and the cabinet style.

20. The computer program product of claim 15, further comprising:
program code for serving an updated version of the web page displaying a second shopping cart as an overlay.
